(19) United States
(12) Patent Application Publication
(10) Pub. No.: US 2006/0059468 A1
(43) Pub. Date: Mar. 16, 2006

(54) Methods and systems for graphically navigating within a debugger program

(75) Inventor: Alan Heirich, Foster City, CA (US)

Correspondence Address: MARTINE PENILLA & GENCARELLA, LLP, 710 LAKEWAY DRIVE, SUITE 200, SUNNYVALE, CA, 94085, US

(73) Assignee: Sony Computer Entertainment Inc., Tokyo (JP)

(21) Appl. No.: 10/938,167

(22) Filed: Sep. 10, 2004

(51) Int. Cl. G06F 9/44

(52) U.S. Cl. 717/125

(57) ABSTRACT

A method for graphically navigating within a debugger program that enables examination of processing by components of a computing system is provided. In this method, a display of the components is generated that enables navigation to debugging windows of the components. The display and navigation methods may reflect a taxonomic organization of the components with hierarchical and peer relationships. The components are represented by graphical icons that may be selectable. If a selection of a component is detected, a debugging window for the selected component is generated, whereby the debugging window is configured to display a state of processes being handled by the component during execution of code for a program. Graphic user interfaces and a system for navigating within a debugger program also are described.

### BACKGROUND OF THE INVENTION

1. Field of the Invention

The present invention relates to computer debugging programs and, more particularly, to methods and systems for navigating within a debugger program for performing debugging operations.

2. Description of the Related Art

Debugging is the process of locating and fixing errors in computer program codes and the engineering of hardware devices. To debug program codes and hardware devices is to start with a problem, isolate the source of the problem, and then fix the problem. A debugger program is a computer program used to find errors in computer program code and hardware devices. In other words, the debugger program is a computer program that facilitates the identification of coding errors at various development stages. The debugger program facilitates the identification of coding errors by enabling a programmer to examine the processing by program codes and hardware devices of a computing system.

Typically, a conventional debugger program is text based and focused only on one particular program or hardware device. In particular, the conventional debugging program uses one window to display the textual information required to debug one program or one hardware device. Accordingly, to debug multiple programs and hardware devices, the conventional debugging program needs to display multiple windows. Such simplistic text based debugging program may be sufficient for simple systems with only few programs and hardware devices to debug. However, to debug a complex system with numerous programs and interrelated hardware devices, the conventional debugging program does not provide any method to manage the navigation between the myriad of debugging windows. As such, to navigate between the different debugging windows associated with each program or hardware device, a programmer needs to have a thorough knowledge of the system architecture and needs to meticulously track the relationships between the programs and hardware devices. However, most programmers design merely a part of the system and may not have a thorough knowledge of the entire system. Accordingly, for a programmer without a thorough knowledge of the entire system architecture, debugging using the conventional debugging program can be burdensome, time consuming, and difficult.

In view of the foregoing, there is a need to provide methods and systems for reducing the complexity for navigation within a debugger program.

### SUMMARY OF THE INVENTION

Broadly speaking, the present invention fills these needs by providing methods and systems for graphically navigating within a debugger program. It should be appreciated that the present invention can be implemented in numerous ways, including as a process, an apparatus, a system, computer readable media, or a device. Several inventive embodiments of the present invention are described below.

In accordance with a first aspect of the present invention, a method for graphically navigating within a debugger program that enables examination of processing by components of a computing system is provided. In this method, a display of the components is generated that enables navigation to debugging windows of the components. The components are represented by graphical icons that may be selectable. If a selection of a component is detected, a debugging window for the selected component is generated, whereby the debugging window is configured to display a state of processes being handled by the component during execution of code for a program.

In accordance with a second aspect of the present invention, a graphical user interface (GUI) for navigating within a debugger program that enables examination of processing by components of a computing system is provided. GUI includes regions representing the components that provide navigation and access to debugging windows of the components. The regions are organized taxonomically according to a categorization of the components and are defined by graphical icons.

In accordance with a third aspect of the present invention, a GUI for navigating within a debugger program that enables examination of processing by components of a computing system is provided. GUI includes a first region defining a first debugging window of a selected component, whereby the first region displays one or more of a textual information and a graphical information associated with execution handling by the selected component. A second region is also included that provides access to second debugging windows of components with parent-child relationships by enabling navigation and selection of one or more of the second debugging windows. GUI also includes a third region that provides access to third debugging windows of components with peer relationships, whereby the third region enables navigation and selection of one or more of the third debugging windows.

In accordance with a fourth aspect of the present invention, a computer readable medium having program instructions for graphically navigating within a debugger program that enables examination of processing by components of a computing system is provided. The computer readable medium includes program instructions for displaying graphical icons of the components in a taxonomic organization, whereby certain ones of the graphical icons of the components are configured to be selectable. Program instructions for detecting selection of a graphical icon of a component are also included. Furthermore, the computer readable medium includes program instructions for generating a debugging window of the selected graphical icon of the component and program instructions for displaying the debugging window for the first component. The debugging window is configured to display a state of processes handled by the component during execution of a code for a program.

In accordance with a sixth aspect of the present invention, a system for graphically navigating within a debugger program is provided. The system includes means for displaying graphical icons of components in a taxonomic organization, whereby certain ones of the graphical icons of the components is configured to be selectable. The system additionally includes means for detecting selection of a graphical icon of a component and means for generating a debugging window of the selected graphical icon of the component. A means for displaying the debugging window for the component is also included, whereby the debugging window is configured to display a state of processes handled by the component during execution of a code for a program.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is a flowchart diagram of a high level overview of a method for navigating within a debugger program, in accordance with one embodiment of the present invention.

FIG. 2 is a more detailed flowchart diagram of a method for graphically navigating within a debugger program, in accordance with one embodiment of the present invention.

FIG. 3 is a schematic diagram of a first graphical user interface (GUI) for navigating within a debugger program, in accordance with one embodiment of the present invention.

FIG. 4 is a schematic diagram of a second GUI for navigating within a debugger program, in accordance with one embodiment of the present invention.

FIG. 5 is a schematic diagram of a third GUI for navigating within a debugger program, in accordance with one embodiment of the present invention.

FIG. 6 shows the use of two different GUIs for graphically navigating within a debugger program, in accordance with one embodiment of the present invention.

### DETAILED DESCRIPTION

An invention is disclosed for methods and systems for navigating within a debugger program. In the following description, numerous specific details are set forth in order to provide a thorough understanding of the present invention. It will be understood, however, by one of ordinary skill in the art, that the present invention may be practiced without some or all of these specific details. In other instances, well known process operations have not been described in detail in order not to unnecessarily obscure the present invention.

The embodiments described herein provide methods and systems for navigating within a debugger program that enables examination of processing by components of a computing system. Essentially, as will be explained in more detail below, a graphic display of components is generated that allows navigation between debugging windows of the components. In one embodiment, the components are organized and displayed in a taxonomy, and such graphic display and organization of components additionally assist a user to visualize the relationships between the components.

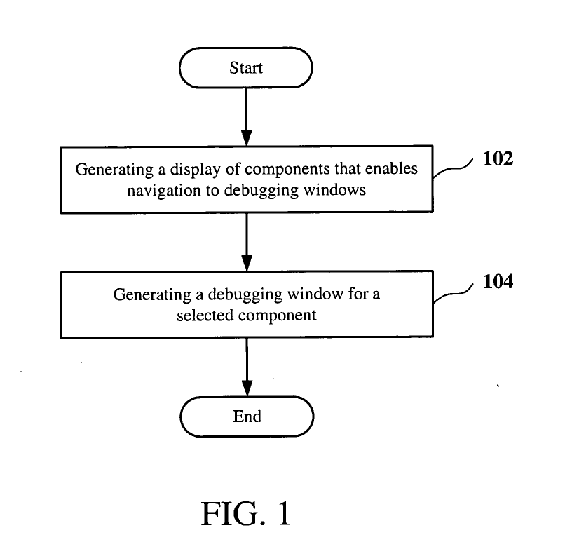

FIG. 1 is a flowchart diagram of a high level overview of a method for navigating within a debugger program, in accordance with one embodiment of the present invention. One skilled in the art would appreciate that the debugger program is a computer program used to find errors in other programs. In other words, the debugger program is a computer program that facilitates the identification of coding errors at various development stages. The debugger facilitates the identification of coding errors by enabling a user to examine the processing by components of a computing system. For example, a debugger program allows the user to stop a program at any point and examine and change the values of variables to facilitate the identification of coding errors. It should be appreciated that the debugger program generates debugging windows that is configured to display a state of processes being handled by a component during execution of code for a program. The debugging window may display any suitable textual and graphical information that facilitate the identification of coding errors. For example, the debugging window can display a column of graphical icons indicating which line in a script is currently executing and which lines have breakpoints. Other exemplary textual and graphical information that may be displayed in the debugging window includes contents of variables, contents of fields, contents of object properties, current memory contents, assembly-language code derived from disassembly of a compiled program, stack of all function calls that have not returned, contents of the general purpose and central processing unit (CPU) status registers, compiler errors, etc.

As shown in FIG. 1, starting in operation 102, a display of components is generated that enables navigation to debugging windows of the components. The components may be any suitable hardware and software components that can be debugged. Exemplary components include systems, program codes, processor arrays, central processing units, vector units, memories, internal registers, processes, threads, programs, vertex shaders, program sources, graphics engines, controllers, graphics processing units, variables, data, etc. In this embodiment, the components are represented by graphical icons that may be selectable and, as will be explained in more detail below, the display of components allows the user to visualize the relationships between the components. It should be appreciated that the displayable appearance of the graphical icons can be defined by any suitable geometric shape (e.g., rectangle, square, circle, triangle, etc.), alphanumeric character (e.g., A, v, t, Q, 1, 9, 10, etc.), symbol (e.g., $, *, @, α, [symbol] , ¤, ♥, etc.), shading, pattern (e.g., solid, hatch, stripes, dots, etc.), and color. In one exemplary embodiment, the graphical icons are textual names of the components. In another exemplary embodiment, as will be explained in more detail below, the graphical icons are graphical arrows.

If a selection of a component is detected, then one or more debugging windows are generated for the selected component in operation 104. As will be explained in more detail below, the graphical icons may be selected through the use of a mouse, a trackball, a keyboard, a touch sensitive display, a microphone for receiving voice commands, or any suitable input device.

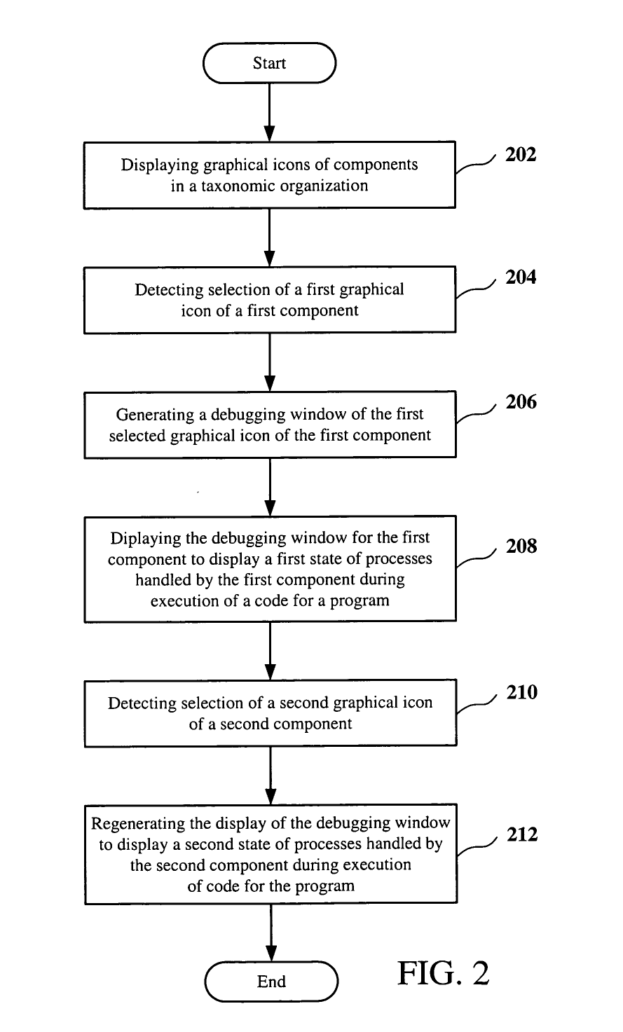

FIG. 2 is a more detailed flowchart diagram of a method for graphically navigating within a debugger program, in accordance with one embodiment of the present invention. Starting in operation 202, graphical icons of components are displayed in a taxonomic organization. It should be appreciated that a taxonomy is a classification of components in an ordered system that indicates the natural relationships between the components. In one exemplary embodiment, the taxonomy organizes components with parent-child relationships vertically and organizes components with peer relationships horizontally. A parent-child relationship is a relationship where each component is ranked relative to other components. For example, a natural parent-child relationship exists between a higher ranked processor and lower ranked threads that are executed within the processor. A peer relationship is a relationship where each component has equal standing. For example, each thread running within the processor are peers.

In this embodiment, certain graphical icons representing the components are also configured to be selectable. As shown in FIG. 2, when a selection of a first graphical icon is detected in operation 204, a debugging window for the first selected graphical icon of the first component is generated in operation 206. Subsequently, the generated debugging window for the first component is displayed in operation 208. The debugging window displays a first state of processes being handled by the first component during execution of a code for a program.

Thereafter, a user may select to view another state of processes being handled by another component by selecting another, second graphical icon of that second component. In one embodiment, if the selection of the second graphical icon is detected in operation 210, then the display of the debugging window is regenerated in operation 212 to display a second state of processes being handled by the second component during execution of the code for the program. Alternatively, instead of regenerating the debugging window, a second debugging window is generated to display the second state of process being handled by the second component if the selection of the second graphical icon is detected in operation 210, in accordance with another embodiment of the present invention. The newly generated second window may replace the debugging window or may be displayed in addition to the debugging window. Additionally, operation 212 may be repeated any number of times to create any number of debugging windows showing different state of processes being handled by different components.

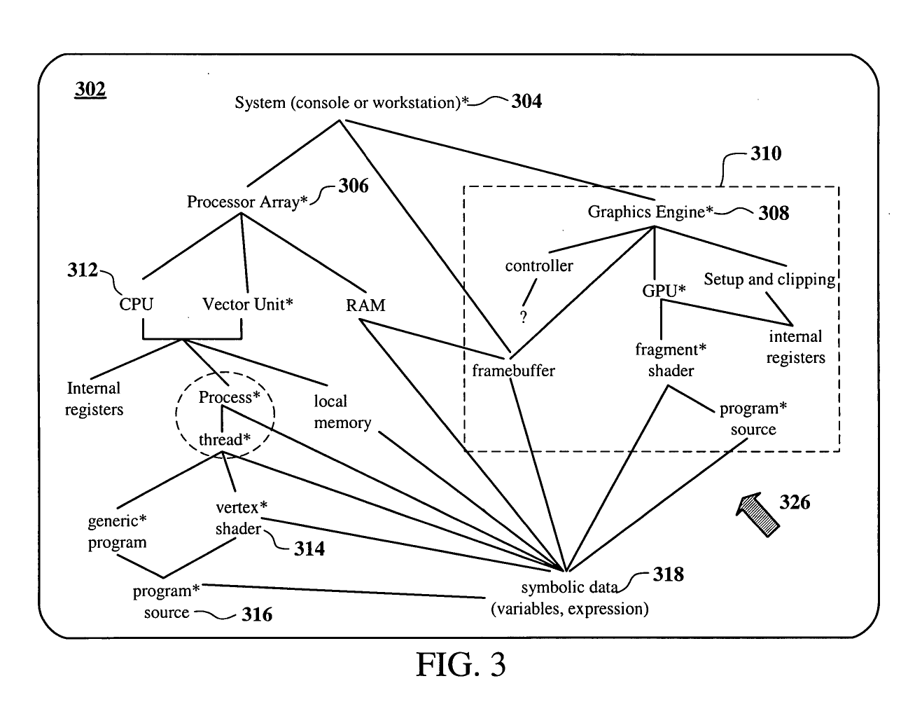

FIG. 3 is a schematic diagram of a first graphical user interface (GUI) for navigating within a debugger program, in accordance with one embodiment of the present invention. GUI 302 as displayed on a display (e.g., a liquid crystal display (LCD), a thin-film transistor (TFT) display, a cathode ray tube (CRT) monitor, etc.) includes a group of regions organized in a taxonomy. Each of the regions represents a component and, in one embodiment as shown in FIG. 3, the regions are defined by texts that identify the components (e.g., system 304, processor array 306, central processing unit (CPU) 312, vector unit, controller, etc.). However, the regions are not limited to texts and, in another embodiment, graphics can be used to identify the components. Furthermore, GUI 302 may include additional texts or graphics to show the relationships between the components. For example, in one embodiment, FIG. 3 includes regions interconnected by lines to show that the connected components are related. In another embodiment, the regions may be encompassed within graphical box 310 to show that the components encompassed within are parts of graphics engine 308.

As shown in FIG. 3, in one embodiment, the regions are organized in a taxonomy according to a categorization of the components. As discussed above, the taxonomy organizes components with parent-child relationships vertically and organizes components with peer relationships horizontally. For example, system 304 includes processor array 306 and graphics engine 308. As such, the higher ranked system 304 is placed above the lower ranked processor array 306 and graphics engine 308. Processor array 306 and graphics engine 308 have equal standing and, as such, the processor array and the graphics engine are peers and are placed at the same level.

By displaying the components and organizing the components in a taxonomy, GUI 302 allows a user to visualize the relationships between the components. Furthermore, GUI 302 allows the user to easily navigate between the components and to select the debugging widows of the components. For instance, GUI 302 aids in the navigation by visually showing the components and corresponding navigation paths. The navigation between and the selection of components can be through the use of a mouse, a trackball, a keyboard, a touch sensitive display, or any suitable input device. As shown in FIG. 3, the user directs cursor 326 using a mouse onto any region that represents a component and clicks the mouse button to select the component. In another example, the user may simply touch any region on a touch sensitive display to select the component.

In this embodiment, the visual graphic display of the components illustrates local transitions (i.e., parent-child and peer-to-peer) and traces the entire path in the taxonomy from the highest ranked component down to the lowest ranked component. For example, a path from CPU 312 to a root component (i.e., the highest ranked component) includes CPU 312, processor array 306, and system 304. On the other hand, a path from vertex shader 314 to the lowest ranked component includes vertex shader 314, program source 316, and symbolic data 318. Accordingly, GUI 302 allows the user to visualize the relationships between the components and to navigate between the components.

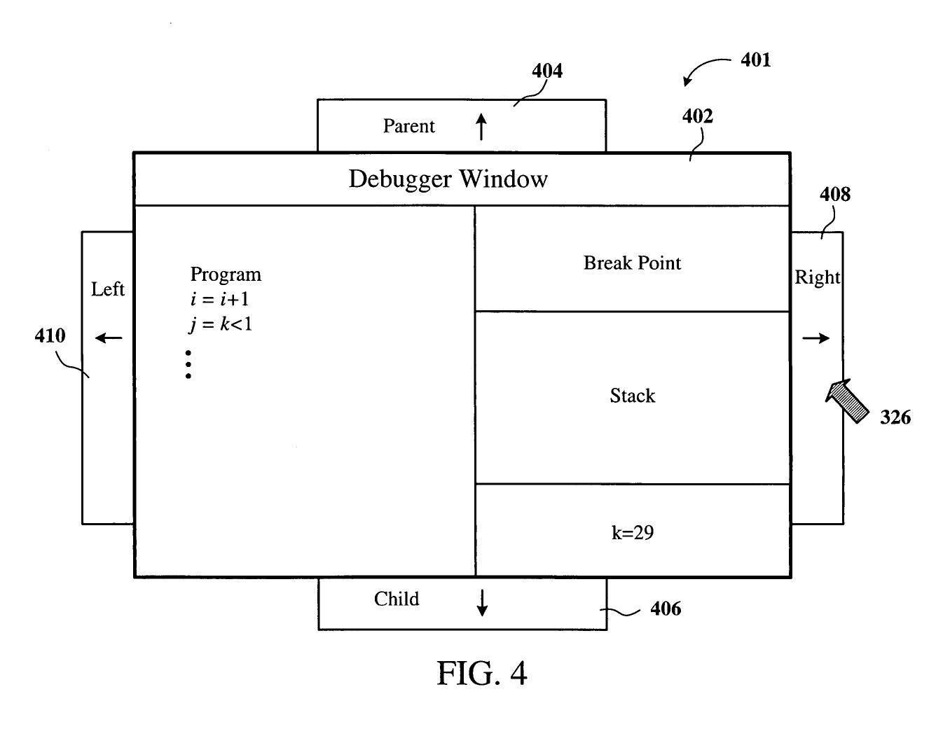

FIG. 4 is a schematic diagram of a second GUI for navigating within a debugger program, in accordance with one embodiment of the present invention. GUI 401 includes debugging window region 402, parent-child navigation regions 404 and 406, and peer navigation regions 408 and 410. Debugging window region 402 shows a debugging window of a selected component. As discussed above, the debugging window can display any suitable textual and graphical information that facilitate the identification of coding errors. Navigation regions 404, 406, 408, and 410 provide navigation and access to additional debugging windows of components. As shown in FIG. 4, navigation regions 404, 406, 408, and 410 are also organized in a taxonomy. In one exemplary embodiment, parent-child navigation regions 404 and 406 are aligned vertically and peer navigation regions 408 and 410 are aligned horizontally with respect to debugging window region 402. Specifically, with regard to parent-child navigation regions 404 and 406, parent navigation region 404 for navigating and accessing debugging windows of higher ranked components is located above child navigation region 406. Accordingly, child navigation region 406 for navigating and accessing debugging windows of lower ranked components is located below parent navigation region 404. On the other hand, since peer components have equal standings, peer navigation regions 408 and 410 for navigating and accessing debugging windows of peer components can be located horizontally at the same level. For example, FIG. 4 shows peer navigation regions 408 and 410 located at the same level to the left and right of debugging window region 402.

In one embodiment, when a selection of any one of navigation regions 404, 406, 408, and 410 is detected, debugging window region 402 is regenerated to provide another state of processes being handled by the selected component during execution of a code for the program. For example, as shown in FIG. 4, debugging window region 402 initially shows a first state of processes being handled by a first component during execution of code of the program. After the user selects peer navigation region 408 with cursor 326, debugging window region 402 is regenerated to show a second state of processes being handled by the selected peer component during execution of the code for the program. In other words, variables, fields, object properties, etc. displayed in debugging window region 402 are regenerated and updated to reflect the state of processes from the viewpoint of the selected component.

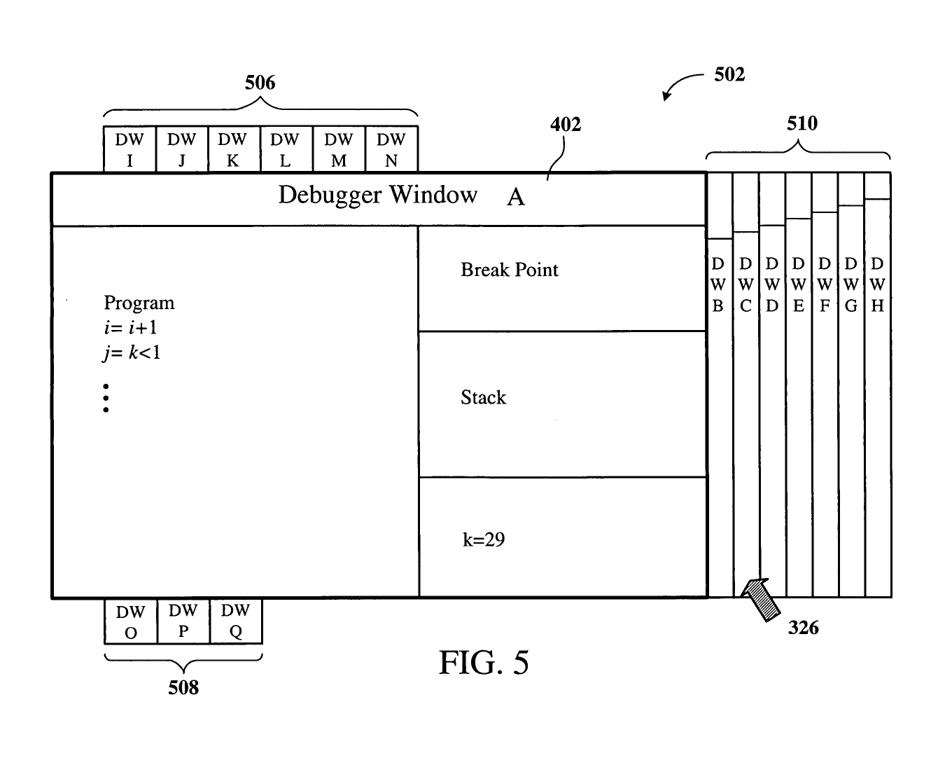

FIG. 4 shows that navigation regions 404, 406, 408, and 410 may be represented by arrows, in accordance with one embodiment of the invention. However, the displayable appearance of navigation regions 404 may be defined by any suitable geometric shape, alphanumeric character, symbol, shading, pattern, and color. For example, FIG. 5 is a schematic diagram of a third GUI for navigating within a debugger program, in accordance with one embodiment of the present invention. Similar to FIG. 4, GUI 502 also includes debugging window region 402. However, GUI 502 of FIG. 5 shows navigation regions 506, 508, and 510 in the shape of tabs (i.e., flaps or short strips), such as navigation regions 506 and 508, and in the shape of partial views of other debugging window regions, such as navigation region 510. Navigation regions 506, 508, and 510 are also organized in a taxonomy where parent navigation region 506 for navigating and accessing debugging windows of higher ranked components are located above child navigation region 508. Vice versa, child navigation region 508 for navigating and accessing debugging windows of lower ranked components are located below parent navigation region 506. In this embodiment, peer navigation region 510 is located to the right of debugging window region 402.

As shown in FIG. 5, navigation regions 506, 508, and 510 includes alphanumeric characters that identifies the debugging window of a particular component. For example, parent navigation region 506 is in the shape of a tab with texts (e.g., debugging window (DW) I, DW J, DW K, etc.) that identify each debugging window. Similarly, peer navigation region 510 includes partial views of other debugging window regions which include texts (e.g., DW B, DW C, DW D, etc.) that identify each debugging window. Accordingly, instead of navigating the debugging windows by scrolling through each debugging window as shown in FIG. 4, the identifying texts of FIG. 5 allows the user to directly select a particular debugging window with cursor 326.

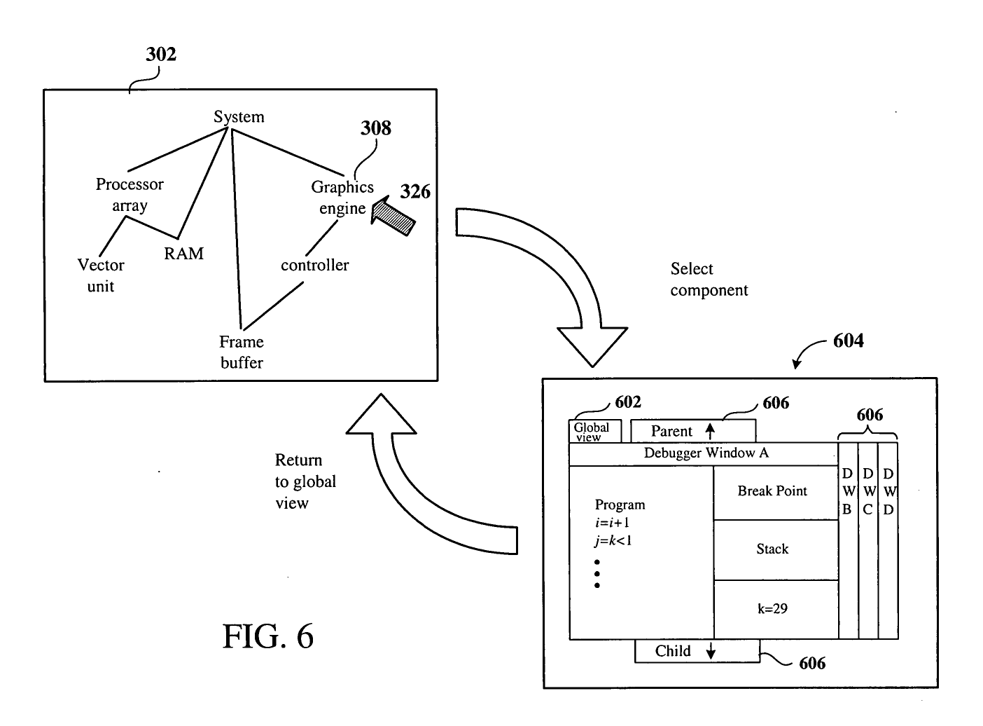

FIGS. 3, 4, and 5 show different embodiments of GUIs that facilitate navigation between components. Additionally, the GUIs may be combined in any combination to facilitate navigation between the components. For example, FIG. 6 shows the use of two different GUIs for graphically navigating within a debugger program, in accordance with one embodiment of the present invention. There are two layers in this embodiment where the first layer includes first GUI 302 shown in FIG. 3 and second layer includes second GUI 604 that is similar to the GUIs of FIGS. 4 and 5. First GUI 302 includes a group of regions organized in a taxonomy where each region is interconnected by lines to show the relationships between the components. First GUI 302 is displayed to show a global view of the components. If a selection of a component is detected in first GUI 302, then second GUI 604 is generated. GUI 604 includes a debugging window of the selected component and associated navigation regions 606 to navigate between the debugging windows as discussed above. In addition, second GUI 604 includes global view region 602 that allows the user to return to first GUI 302 when selected. In other words, the selection of global view region 602 returns the user to first GUI 302 for navigation within the debugger. The use of two different GUIs 302 and 604 allows the user to navigate between components more quickly and efficiently when compared to the use of one GUI.

FIG. 6 shows the use of two GUI layers where the first layer shows a global view and the second layer shows a debugging window. However, a more complicated computer architecture may require more layers of GUIs for graphically navigating within the debugger program. For example, in another embodiment, a more complicated computer architecture may require a user to navigate within multiple layers of GUIs of FIG. 3 before being able to access the GUIs of FIGS. 4 and 5.

Any number of suitable layouts can be designed for region layouts illustrated above as FIGS. 3-6 do not represent all possible layout options available. The displayable appearance of the regions can be defined by any suitable geometric shape (e.g., rectangle, square, circle, triangle, etc.), alphanumeric character (e.g., A, v, t, Q, 1, 9, 10, etc.), symbol (e.g., $, *, @, α, [symbol] , ¤, ♥, etc.), shading, pattern (e.g., solid, hatch, stripes, dots, etc.), and color. Furthermore, for example, navigation regions 404, 406, 408, and 410 of FIG. 4, or any other region, may be omitted or dynamically assigned. It should also be appreciated that the regions can be fixed or customizable. In addition, the computing devices may have a fixed set of layouts, utilize a defined protocol or language to define a layout, or an external structure can be reported to the computing device that defines a layout. Finally, selecting and clicking on a region of GUI as discussed above triggers code to cause the functionality described herein.

Additionally, any of the operations described herein that form part of the invention can be performed by any suitable structural “means” that provide capability for performing the recited functionality. For instance, an exemplary system for graphically navigating within a debugger program includes means for displaying graphical icons of the components in a taxonomic organization; means for detecting selection of a graphical icon of a component; means for generating a debugging window of the selected graphical icon of the component; and means for displaying the debugging window for the component, whereby the debugging window is configured to display a state of processes handled by the component during execution of a code for a program. It should be appreciated that the system can be of any type, such as desktop computers, server computers, laptop computers, game consoles, game units, and other portable devices.

In summary, the above described invention provides methods and systems for graphically navigating within a debugger program that enables the examination of processing by components of a computing system. When compared to the conventional debugger program, the generation of a display of components allows the user to more easily visualize the relationships between the components and enables navigation between the debugging windows of the components. In effect, the GUIs described above assist the user to quickly and easily visualize, understand, and navigate the system being debugged. Accordingly, the degree of difficulty required to utilize the debugger program is reduced, and the above described invention makes the use of the debugger program easier for a user without a thorough knowledge of the system architecture.

With the above embodiments in mind, it should be understood that the invention may employ various computer-implemented operations involving data stored in computing systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data which can be thereafter read by a computing system. The computer readable medium also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computing system so that the computer readable code is stored and executed in a distributed fashion.

The above described invention may be practiced with other computing system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. A method for graphically navigating within a debugger program that enables examination of processing by components of a computing system, comprising method operations of:
generating a display of the components that enables navigation to debugging windows of the components, the components being represented by graphical icons that may be selectable; and
if a first selection of a first component is detected, generating a first debugging window for the first selected component, the first debugging window being configured to display a first state of processes being handled by the first component during execution of code for a program.

2. The method of claim 1, further comprising:
if a second selection of a second component is detected, regenerating the first debugging window to display a second state of processes being handled by the second component during execution of the code for the program.

3. The method of claim 1, further comprising:
if a second selection of a second component is detected, generating a second debugging window to display a second state of processes being handled by the second component during execution of the code for the program.

4. The method of claim 1, wherein the components are organized in a taxonomy to enable relationships between the components to be displayed, the taxonomy organizing components with parent-child relationships vertically and organizing components with peer relationships horizontally.

5. The method of claim 1, wherein certain ones of the components are interconnected by lines to enable relationships between the components to be displayed.

6. The method of claim 1, wherein the components are defined by one or more of a system, a processor array, a central processing unit (CPU), a vector unit, a memory, an internal register, a process, a thread, a program, a vertex shader, a program source, a graphics engine, a controller, a graphics processing unit (GPU), a variable, and data.

7. The method of claim 1, wherein the selection of the component is defined by one or more of a mouse input, a keyboard input, a trackball input, a voice input, and a touch sensitive display input.

8. A graphical user interface (GUI) for navigating within a debugger program that enables examination of processing by components of a computing system, comprising:
regions representing the components that provide navigation and access to debugging windows of the components, the regions being organized taxonomically according to a categorization of the components and being defined by graphical icons.

9. The GUI of claim 8, wherein taxonomy organizes components with parent-child relationships vertically and organizes components with peer relationships horizontally.

10. The GUI of claim 8, wherein certain ones of the regions are interconnected by lines.

11. The GUI of claim 8, wherein the graphical icons are names of the components in text.

12. The GUI of claim 8, wherein the graphical icons are defined by one or more of a graphical shape, an alphanumeric character, and a symbol.

13. A graphical user interface (GUI) for navigating within a debugger program that enables examination of processing by components of a computing system, comprising:
a first region defining a first debugging window of a selected component, the first region displaying one or more of a textual information and a graphical information associated with execution handling by the selected component;
a second region providing access to second debugging windows of components with parent-child relationships, the second region enabling navigation and selection of one or more of the second debugging windows; and
a third region providing access to third debugging windows of components with peer relationships, the third region enabling navigation and selection of one or more of the third debugging windows.

14. The GUI of claim 13, wherein the second region is aligned vertically with respect to the first region.

15. The GUI of claim 13, wherein the second region for accessing parent components of the selected component is located at a top portion of the first region.

16. The GUI of claim 13, wherein the second region for accessing child components of the selected component is located at a bottom portion of the first region.

17. The GUI of claim 13, wherein the third region is aligned horizontally with respect to the first region.

18. The GUI of claim 13, wherein the third region is located to one of a left portion and a right portion of the first region.

19. The GUI of claim 13, wherein each of the second and third regions is defined by one or more of an arrow, a tab, and a partial view of one of the second and third debugging windows.

20. A computer readable medium having program instructions for graphically navigating within a debugger program that enables examination of processing by components of a computing system, comprising:
program instructions for displaying graphical icons of the components in a taxonomic organization, certain ones of the graphical icons of the components being configured to be selectable;
program instructions for detecting selection of a first graphical icon of a first component;
program instructions for generating a debugging window of the selected first graphical icon of the first component; and
program instructions for displaying the debugging window for the first component, the debugging window being configured to display a first state of processes handled by the first component during execution of a code for a program.

21. The computer readable medium of claim 20, further comprising:
program instructions for detecting selection of a second graphical icon of a second component; and
program instructions for regenerating the display of the debugging window to display a second state of processes handled by the second component during execution of the code for the program.

22. The computer readable medium of claim 20, wherein the taxonomic organization organizes components with parent-child relationships vertically and organizes components with peer relationships horizontally.

23. A system for graphically navigating within a debugger program, comprising:
means for displaying graphical icons of components in a taxonomic organization, certain ones of the graphical icons of the components being configured to be selectable;
means for detecting selection of a graphical icon of a component;
means for generating a debugging window of the selected graphical icon of the component; and
means for displaying the debugging window for the component, the debugging window being configured to display a state of processes handled by the component during execution of a code for a program.

24. The system of claim 23, wherein the graphical icons are defined by one or more of a textual name, an arrow, a tab, and a partial view of other debugging windows.
